(19) United States
(12) Patent Application Publication
(10) Pub. No.: US 2019/0263324 A1
(43) Pub. Date: Aug. 29, 2019

(54) External cargo carrying system for vehicles

(71) Applicant: Ryan William Kanigan, Vancouver (CA)

(72) Inventor: Ryan William Kanigan, Vancouver (CA)

(21) Appl. No.: 15/906,495

(22) Filed: Feb. 27, 2018

(51) Int. Cl. B60R 9/06; B60R 9/12; B60R 9/10

(52) U.S. Cl. CPC B60R 9/06; B62D 43/02; B60R 9/10; B60R 9/12

(57) ABSTRACT

A cargo carrier that mounts to an external vehicle spare tire mount. In some embodiments, the carrier may include a pair of arms to support a bicycle. In some embodiments, the carrier may include a mount for ski equipment as single or multiple mounts for more than one pair of skis, or multiples of other larger equipment such as snowboards or split boards. In some embodiments, the carrier may include mounts for miscellaneous items such as luggage, fuel canisters, or other goods that can fit in the carrier.

### CROSS-REFERENCE TO RELATED APPLICATION

This application claims priority to U.S. Provisional Application Ser. No. 62/556,197 filed 8 Sep. 2017 (“Parent Provisional”), and hereby claims benefit of the filing dates thereof pursuant to 37 CFR § 1.78(a)(4). The subject matter of the Parent Provisional, in its entirety, is expressly incorporated herein by reference.

### FIELD OF THE INVENTION

The present disclosure relates to vehicle fittings specially adapted for sports gear and load carriers for transporting miscellaneous cargo.

### BACKGROUND OF THE INVENTION

People frequently carry cargo on the outside of vehicles. Cargo can be carried on the top, rear or sides of vehicles for specialized or general unspecified cargo.

Specialized racks are available for securing recreational items typically on top or on the rear of vehicles. For example, recreational items can be secured on a pair of crossbars on top of a vehicle with a cargo specific carrier, such as boat, bike, ski/snowboard carrier, or other suitable accessory attachment. Carrying cargo outside the vehicle is a convenient way to increase carrying capacity, particularly with respect to inherently large items that usually don't fit well inside a vehicle, for example, boats, bikes, skis, and surfboards. One such top mounted configuration is described in U.S. Pat. No. 9,283,884. Roof or top mounted racks inherently require additional height and attention for operating and parking a vehicle equipped with a top mounted device, for example driving and parking in height restricted parking areas common to apartment buildings or office space.

Bicycle carriers include apparatus for their attachment to the carrying vehicle; among others, one type of bike carrier is mounted behind the vehicle, in abutment with a backside thereof, such as the trunk, hatch-back or tailgate. In this regard, such load carriers are typically referred to as trunk-mount bicycle carriers or racks. Generally, such trunk-mount bicycle carriers will have portions that project rearwardly from the back of the vehicle and which are configured for receiving bicycles thereupon. The distance at which these bicycle engaging portions of the rack extend backwards can be significant. As a result, it is typically desirable to retract these backward extending, bicycle engaging portions of the rack into a traveling configuration when the rack is not in use, but while the rack is still mounted to the vehicle. Thus, arrangements for achieving such retracted or space-saving configurations are needed, as can bee seen in U.S. Pat. No. 9,744,910 which demonstrates one solution for space-saving by utilizing retraction of a rearwardly portion of its device.

Vehicle mounted carrier systems for unspecified general cargo often consist of multi-component systems of rails and clamps designed to fit specific vehicle dimensions, as can be seen in U.S. Pat. No. 9,580,004. These types of systems are useful for the general public when the specific items to be carried are unknown in size or objects of different sizes must be carried, such as is needed with general construction contracting.

Vehicle mounted carrier systems as described above also often require the use of additional physical attachment features in order to secure the system to the vehicle, and are designed to fit multiple specific vehicle dimensions as described in U.S. Pat. No. 9,718,410 B2. This system disclosed in U.S. Pat. No. 9,718,410 are configured to be used on multiple vehicle types and can be dimensionally adjusted for specific vehicle requirements.

Vehicle mounted carrier systems utilizing a rear-mounted spare tire have been disclosed. Hendrick (U.S. Pat. No. 2,106,503); Kesler (U.S. Pat. No. 3,972,457) and Wyers (U.S. Pat. No. 5,215,232) describe a carrier that attaches to a spare tire using a wire frame and bracket system. Davies (U.S. Pat. No. 4,189,074) and Patrick et al. (U.S. Pat. No. 5,108,020) describe attaching an external carrier for both a spare tire and cargo.

Carrying systems can be complex and lead to restrictions in use of vehicles as in the example of using vehicles with roof mounted racks in height restricted parking areas or racks that extend far behind vehicles and occupy additional rearward space which may not fit existing parking spaces, or cause other spatial issues with adjacent vehicles or building structures when hinged rearward opening doors are opened up or to one side, therefore innovation is still needed to improve carriers that mount to a vehicle for multiple uses.

### SUMMARY OF THE INVENTION

The present disclosure provides a carrier that mounts to an external vehicle spare tire mount. In some embodiments, the carrier may include a pair of arms to support a bicycle. Each arm may include one or more securing devices each including a strap to contact a frame region of a bicycle and a pair of buckles to fasten the strap over the frame region. In some embodiments, the carrier may include a mount for ski equipment as single or multiple mounts for more than one pair of skis, or multiples of other larger equipment such as snowboards or split boards. The mount may include a pair of user-actuated coupling members, such as a wedge member and a retractable retainer. One of the coupling members (e.g., the retainer) may serve as a backup for the other coupling member to improve safety, which may include the use of a permanently fixed retaining member, with fixation to the rack or in some cases a vehicle attachment point. In some embodiments, the carrier may include mounts for miscellaneous items such as luggage, fuel canisters, or other goods that can fit in the carrier.

In some embodiments, the carrier may provide a modifiable attachment for people to create their own custom holding assemblies.

In some embodiments, the invention can be configured so the base rack is not protruding farther than the existing rear-mounted spare tire, thus no additional space is needed for storing or parking a vehicle to accommodate the rack system, including height which can be a major limiting factor for roof-mounted rack systems and severely height restricted areas such as parking garages. Height restrictions are particularly critical for sport utility vehicles that approach height restrictions as well as parking spot length restrictions without a rack system installed.

In some embodiments, the invention can be configured so the base rack can fit a wide range of vehicles with rear spare tire holders, by utilizing multi-hole patterns that can fit multiple arrangements of lug bolt locations for different vehicle types, thus reducing the number of carrier models required versus requiring specialized fitments for each vehicle model.

In some embodiments, the carrier may include optional nuts, circlip or other mechanical retainers that can fit onto a rear tire mount bolt, to hold the carrier in place when spare tires are removed.

In some embodiments, the carrier may be fabricated by a single or combined method of machining, stamping, laser cutting, water jet cutting, electrical discharge machining, injection moulding and bending, and/or assembly by welding or removable fasteners.

### BRIEF DESCRIPTION OF THE DRAWINGS

These and other features of the invention will become more apparent in the following detailed description in which reference is made to the appended drawings.

FIG. 1 is a perspective view of a typical vehicle with an external spare tire attached to the vehicle via lug nuts;

FIG. 2 is a perspective view of a typical vehicle with an external spare tire carrier attached to the vehicle rear body panel;

FIG. 3 is a perspective view of an embodiment of the present invention attached to an external spare tire carrier attached to the vehicle rear body panel with the tire removed;

FIG. 4 is a perspective view of an embodiment of the present invention attached to an external spare tire carrier attached to the vehicle rear body panel with the spare tire reattached;

FIG. 5 is a front view of an embodiment of the present invention as a flattened sheet metal or plastic blank;

FIG. 6 is a front view of an embodiment of the present invention as a flattened sheet metal or plastic blank with attachment holes;

FIG. 7 is a front view of an embodiment of the present invention as a flattened sheet metal or plastic blank with spacer holes;

FIG. 8 is a perspective view of an embodiment of the present invention showing the main body of the carrier with two variable attachment points;

FIG. 9 is a top view of an embodiment of the present invention showing the main body of the carrier with uniform thickness;

FIG. 10 is a front view of an embodiment of the present invention showing the main body of the carrier with two variable attachment points;

FIG. 11 is a perspective view of an embodiment of the present invention showing the main body of the carrier with one variable attachment point;

FIG. 12 is a perspective view of an embodiment of the present invention showing the main body of the carrier being joined with a cargo carrier;

FIG. 13 is a perspective view of an embodiment of the present invention showing the main body of the carrier joined with a cargo carrier plate;

FIG. 14 is a perspective view of an embodiment of the present invention showing the main body of the carrier being joined with a ski carrier;

FIG. 15 is a perspective view of an embodiment of the present invention showing the main body of the carrier joined with skis being loaded in to a carrier;

FIG. 16 is a side and detail view of an embodiment of the present invention showing the main body of the carrier joined with skis being loaded in to a carrier;

FIG. 17 is a perspective view of an embodiment of the present invention showing the main body of the carrier joined with skis being loaded in to a carrier having areas for strap attachments;

FIG. 18 is a perspective view of an embodiment of the present invention carrying skis attached to an external spare tire carrier attached to the vehicle rear body panel with the spare tire reattached;

FIG. 19 is a perspective view of an embodiment of the present invention showing the main body of the carrier with one variable attachment point and one hem;

FIG. 20 is a perspective view of an embodiment of the present invention showing the main body of the carrier with one variable attachment point and no hem;

FIG. 21 is a perspective view of an embodiment of the present invention showing the main body of the carrier joined with a circular cargo holder loaded in to a carrier;

FIG. 22 is a perspective view of an embodiment of the present invention showing the main body of the carrier with one variable attachment point and one blank cargo plate;

FIG. 23 is a perspective view of an embodiment of the present invention showing a variable use cargo plate;

FIG. 24 is a perspective view of an embodiment of the present invention showing the main body of the carrier with two integrated variable attachment points and no hem;

FIG. 25 is a perspective view of an embodiment of the present invention showing the main body of the carrier being joined with a bicycle carrier;

FIG. 26 is a side view of an embodiment of the present invention showing a bicycle holding plate;

FIG. 27 is a front view of an embodiment of the present invention showing a bicycle holding plate;

FIG. 28 is a perspective view of an embodiment of the present invention showing a variable use cargo plate with an integrated ledge;

FIG. 29 is a perspective view of an embodiment of the present invention showing the main body of the carrier being joined with a bicycle carrier carrying a bicycle frame;

FIG. 30 is a front view of an embodiment of the present invention showing the main body of the carrier being joined with a bicycle carrier carrying a bicycle frame;

FIG. 31 is a perspective view of an embodiment of the present invention showing the main body of the carrier being variably adjusted and joined with a bicycle carrier;

FIG. 32 is a perspective view of an embodiment of the present invention showing the main body of the carrier being variably adjusted and joined with a bicycle carrier using lock pins;

FIG. 33 is a front view of an embodiment of the present invention showing the main body of the carrier with one extended variable attachment point and multiple sets of attachment holes.

FIG. 34 is a perspective view of an embodiment of the present invention showing the main body of the carrier with a ski carrier.

### DETAILED DESCRIPTION OF THE INVENTION

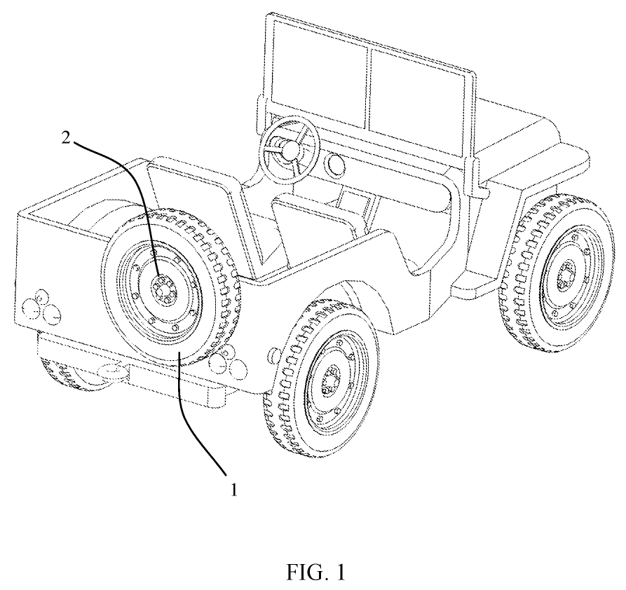

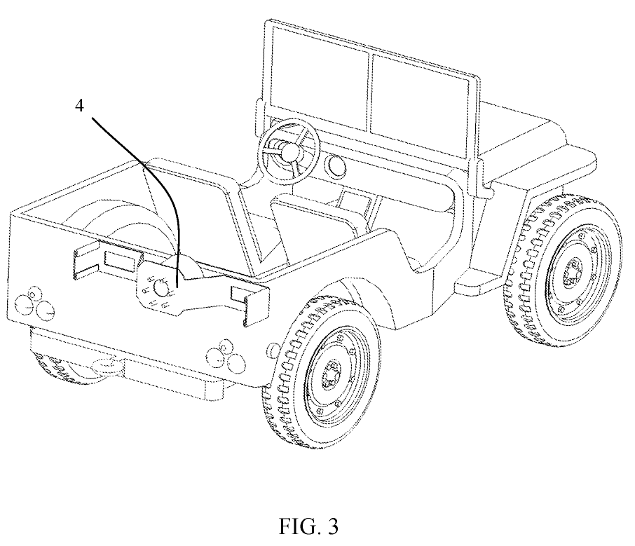

The present description includes several embodiments of the invention shown in reference numbers in FIG. 1 through FIG. 34.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Unless defined otherwise, all technical and scientific terms used herein have the same meaning as commonly understood by one of ordinary skill in the art to which this invention belongs.

Several definitions that apply throughout this disclosure will now be presented.

As used herein, the term “about” refers to an approximately +/−25% variation from a given value, including any angular depictions of the invention components. It is to be understood that such a variation is always included in any given value provided herein, whether or not it is specifically referred to.

Directional terms such as “top”, “bottom”, “left”, “right”, “front”, and “rear” are used in the following description for the purpose of providing relative reference only, and are not intended to suggest any limitations on how any article is to be positioned during use, or to be mounted in an assembly or relative to an environment.

The term “coupled” is defined as connected, whether directly or indirectly through intervening components, and is not necessarily limited to permanent connections. The connection can be such that the objects are permanently connected or releasably connected.

The phrase “abuttingly engaged” is defined as being in contact with portions of a vehicle, whether directly or indirectly through intervening components, and is not necessarily limited to permanent connections. The contact can be such that the objects are permanently connected or releasably connected, or unconnected by in physical contact.

The term “substantially” is defined to be essentially conforming to the particular dimension, shape or other feature that is modified by the word “substantially”, such that the feature of the component need not be exact.

The term “comprising,” when utilized, means “including, but not necessarily limited to”; it specifically indicates open-ended inclusion or membership in the so-described combination, group, series and the like. The term “hole” means any shape geometry that penetrates completely through the cargo carrier material, but is not limited to any specific shape.

Relative spatial references such as “above,” “below,” “upper,” “lower,” “rearward,” “rearwardly,” “forward,” “over,” “under,” “horizontal” “vertical” and the like are to be taken and interpreted as shown in the drawings as if the load carrier is mounted to a carrying vehicle, namely a rear spare tire mount, in an installed orientation, and the load carrier is configured to either the load supporting or travelling configurations as is described, and as would be understood by persons skilled in the art.

This section provides an overview of an exemplary vehicle-mounted carrier system, namely a carrier that mounts interchangeably to a rearward tire mount.

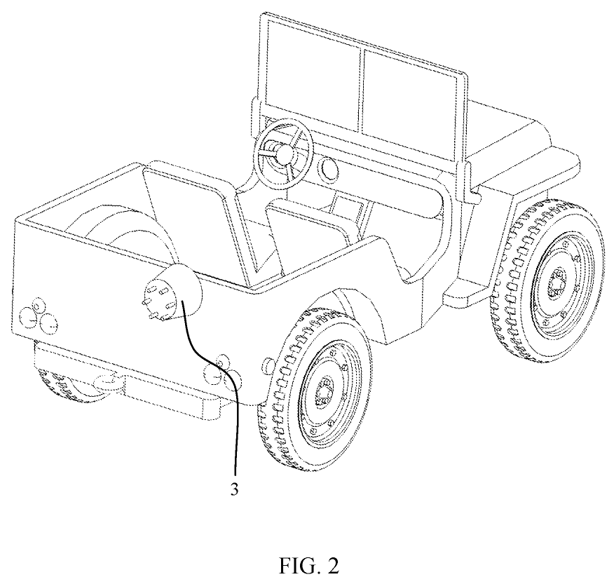

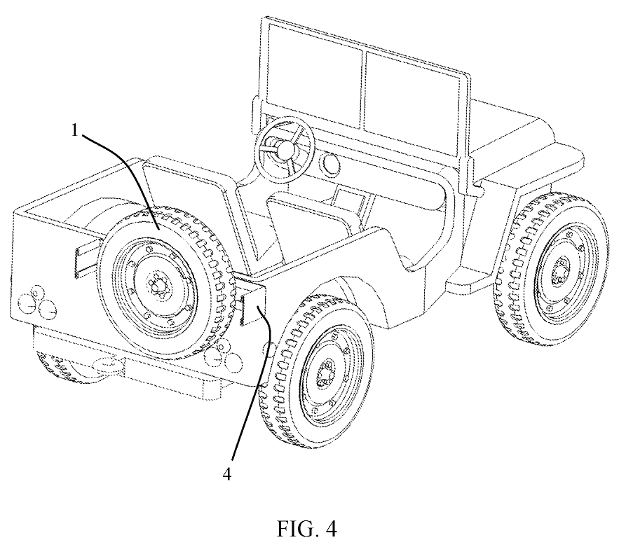

Referring to the figures, one example embodiment of a cargo load carrier 04 is shown in FIG. 4, which can be configured to mount on a rearward section of a vehicle. Vehicles with rear mount spare tires 01 attached using lug nuts 02 as in FIG. 1 commonly utilize rearward tire mounts 03 as in FIG. 2. One example embodiment of a cargo load carrier 04 can be placed over rearward tire mounts 03 and be secured in place by replacing the spare tire 01 as in FIG. 4 whereby the cargo load carrier 04 abuttingly engages the rearward tire mounts 03. This embodiment can be provided to fit any vehicle with rear mount spare tire carrier. Spacer materials such as metal or plastic or other appropriate material such as washers can be provided between the carrier 04 and the rear mount 03 to reduce wear and vibration.

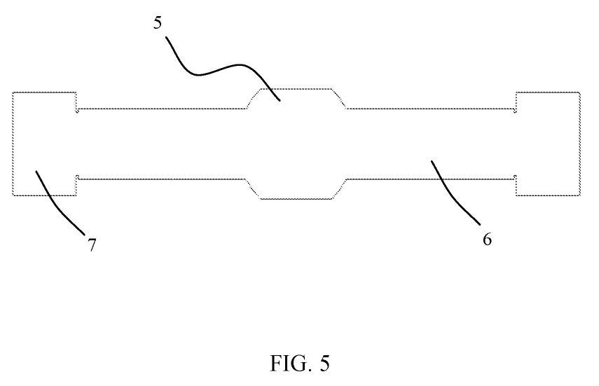

As depicted in FIG. 5 one example embodiment of a cargo load carrier 04 has three elements, which may be manufactured as a single entity or assembled from separate entities, namely a tire mount segment 05, a variable length and width support member 06, and a variably configured equipment attachment segment 07. For manufacturing purposes, the segments can be manufactured in one flat piece as shown in FIG. 5 and later bent to a desired shape, or alternatively each segment can be manufactured separately and joined by mechanical, chemical or other means such as would be known by those skilled in the art of metal or plastic fabrication. Segments 05, 06 and 07 may be configured so that the distance between the segments can be lengthened or shortened as desired or to fit specific vehicle models. Cargo load carrier 04 may (but is not required to) include, or be constructed of, a material that allows the carrier to maintain a substantially rigid shape, including in an arcuate shape.

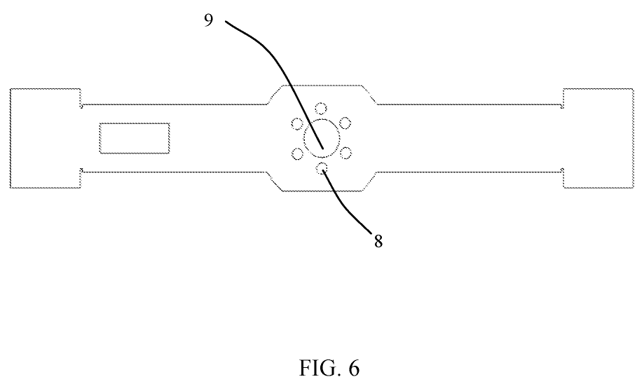

As depicted in FIG. 6 one example embodiment of a cargo load carrier 04 has a radial plurality of holes 08 arranged in a circular pattern. The plurality of holes 08 provides for placing the carrier 04 onto the rearward tire mount lug bolts 03. While shown as circles, the holes 08 could be any shape that allows the lug bolts 02 to pass through the load carrier 04, which could include hole shapes, gussets or bosses that allow a plurality of tire mount lug bolts to protrude through the carrier 04. Other clearance holes 09 may be added as required to allow the carrier 04 to abuttingly engage the rearward tire mounts 03 for rearward tire mounts that have protruding features other than lug bolts 02. The plurality of holes 08 may be configured to fit more than type one vehicle model spare tire carrier.

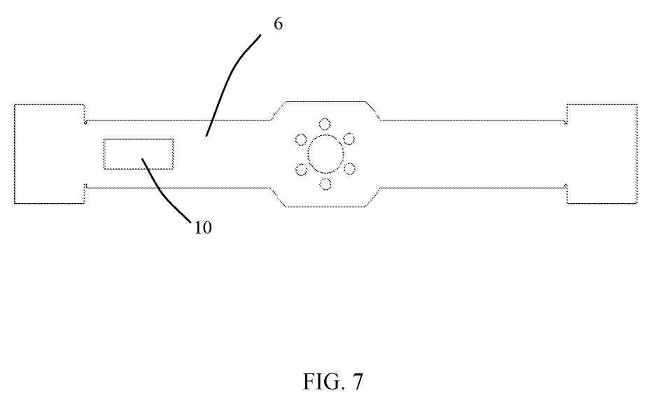

As depicted in FIG. 7 one example embodiment of a cargo load carrier 04 has a clearance hole 10 in the variable length and width support member 06. Clearance region 10 may be added in singular forms as shown or as a plurality of holes as required to allow the carrier 04 to abuttingly engage the rearward tire mounts 03 or other features that may protrude from the rearward panels of vehicles, or rearward tire mounts that have protruding features other than lug bolts 02. Clearance region 10 may also be provided as bosses, gussets or other metal or plastic forming clearance regions or other means such as would be known by those skilled in the art of metal or plastic fabrication.

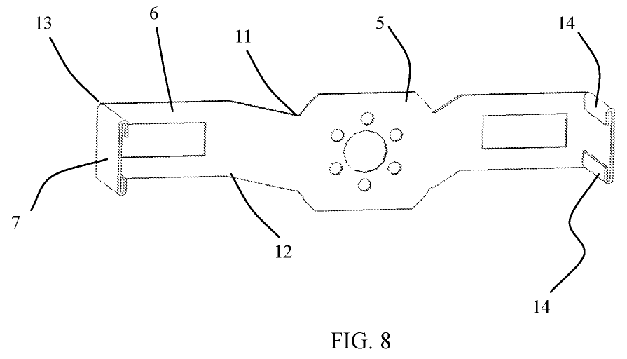

As depicted in FIG. 8 one example embodiment of a cargo load carrier 04 has been formed using bending 11 adjacent but not necessarily directly adjacent to the tire mount segment 05, bending 12 along any length the variable length and width support member 06, and bending 13 at or near a variably configured equipment attachment segment 07. While only one bend is shown, multiple bends in each segment may be added at any point in the segment. The equipment attachment segment 07 is shown with two hems 14 that can be utilized to abuttingly engage equipment holders that are permanently connected or releasably connected to the equipment segment. Cargo load carrier 04, and segments 05, 06 and 07 may (but is not required to) include, or be constructed of, a material that allows the carrier to maintain a substantially rigid shape, including in an arcuate shape.

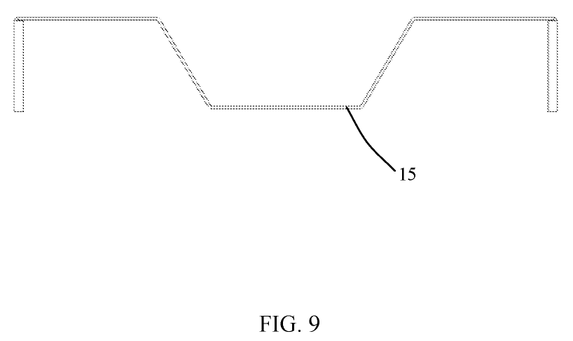

As depicted in FIG. 9 one example embodiment of a cargo load carrier 04 is shown as a single thickness 15 however multiple thicknesses in any single or multiple segments can be utilized.

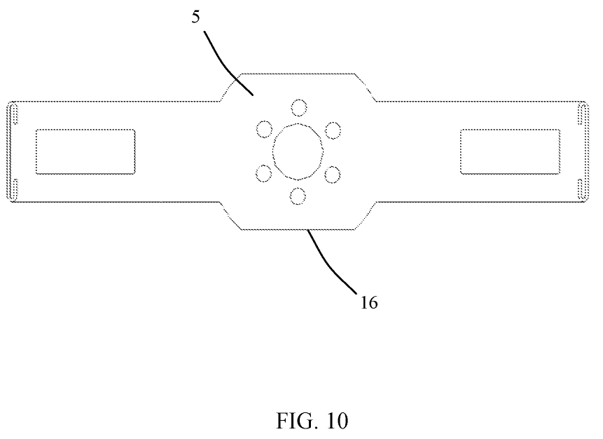

As depicted in FIG. 10 one example embodiment of a cargo load carrier 04 is shown as having a flat portion 16 of the tire mount segment 05 however full round segments can be constructed, or a combination of clearance holes, bosses, gussets or other metal or plastic forming clearance regions or other means such as would be known by those skilled in the art of metal or plastic fabrication.

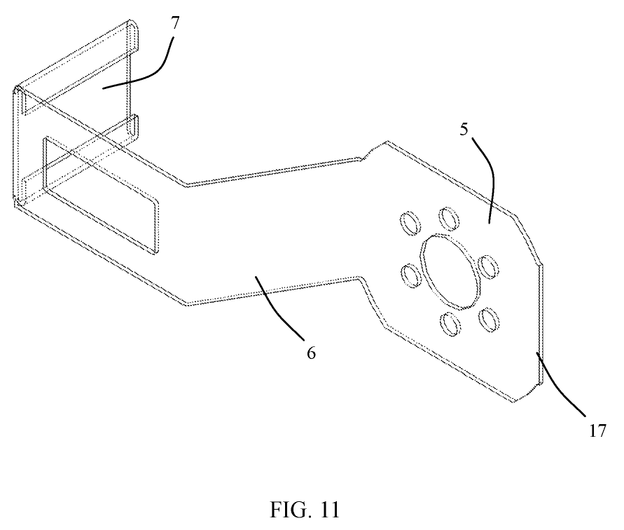

As depicted in FIG. 11 one example embodiment of a cargo load carrier 04 is shown as having a single side with three main frame elements, a tire mount segment 05, a variable length and width support member 06, and a variably configured equipment attachment segment 07. This configuration could be used where one single equipment mount would be desired, or where a plurality of cargo holders is desired whereby a plurality of holders can be stacked abuttingly on a tire mount at different rotational angles.

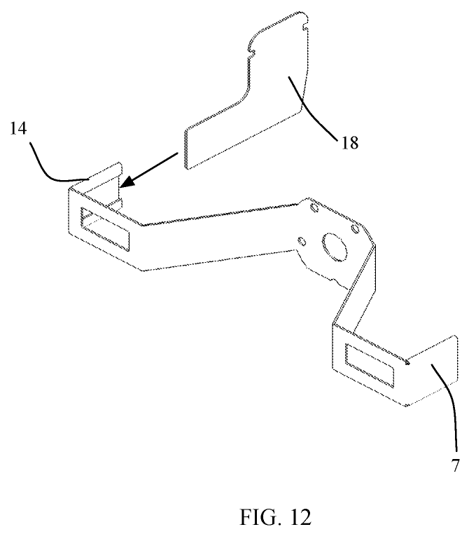

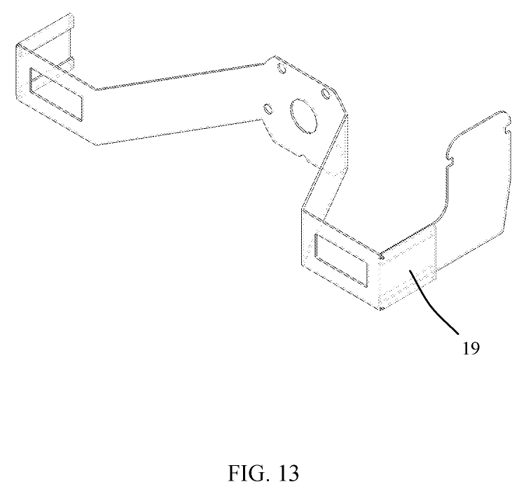

As depicted in FIG. 12 and FIG. 13 one example embodiment of the carrier 04 comprises an equipment-retaining segment 18 abuttingly engaged 19 with the equipment attachment segment 07 allowing for equipment retainers 18 that are permanently connected or releasably connected to the equipment segment. The equipment-retaining segment 18 can be slidingly cooperative and engaged with the hems 14 of the carrier 04.

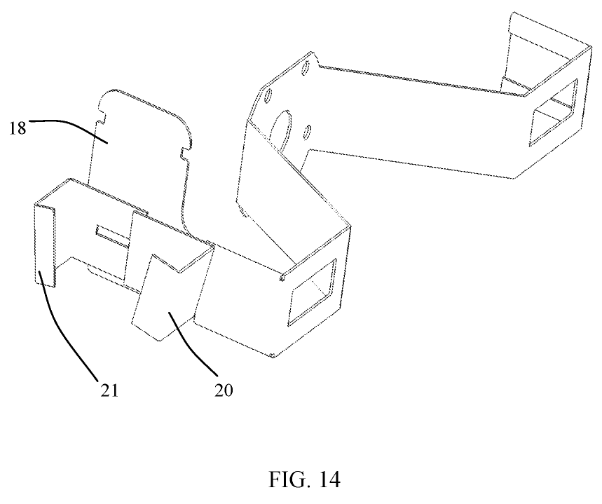

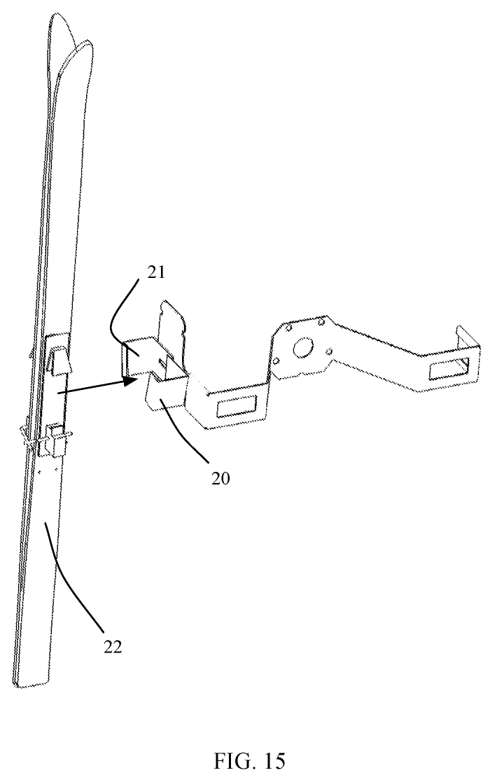

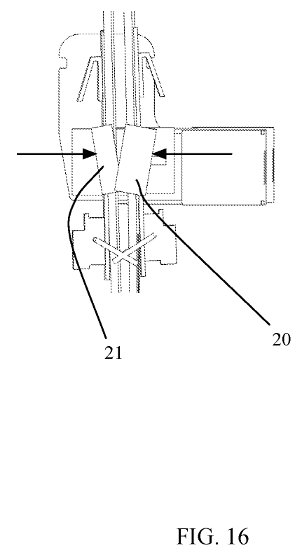

As depicted in FIG. 14 one example embodiment of the carrier 04 comprises an assembly 20, 21 for retaining skis or snowboards or other sport equipment that can be retained in a similar manner. Assembly elements 20 and 21 are permanently or releasably engaged with equipment-retaining segment 18. The equipment-retaining segment 18 can be slidingly cooperative and engaged with assembly elements 20 and 21 to retain equipment 22 as shown in FIG. 15 and FIG. 16, and retained with set screws, spring pins, solid or flexible straps, or adjustable fasteners such as would be known by those skilled in the art of metal or plastic fabrication. Cargo load carrier 04, and segments 20 and 21 may (but is not required to) include, or be constructed of, a material that allows the carrier to maintain a substantially rigid shape, including in an arcuate shape.

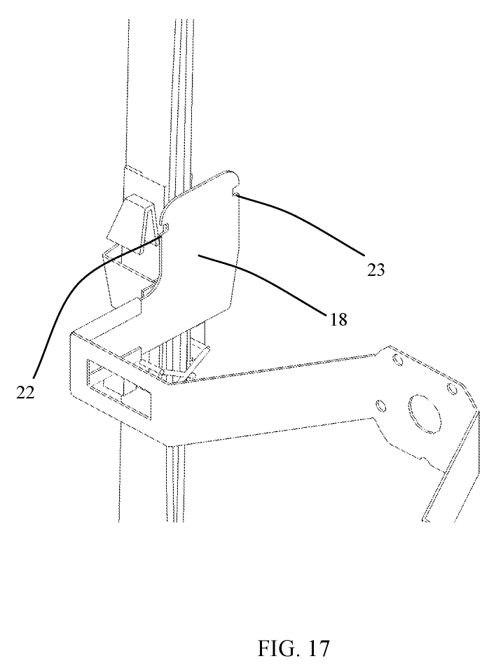

As depicted in FIG. 17 one example embodiment of the carrier 04 comprises assembly elements 22 and 23 are engaged with or integral with equipment-retaining segment 18 allowing for equipment-retaining solid or flexible straps which are permanently or releasably connected to the equipment and carrier 04. Assembly elements 22 and 23 may comprise a combination of holes, notches, bosses, gussets or other metal or plastic forming clearance regions or other means such as would be known by those skilled in the art of metal or plastic fabrication.

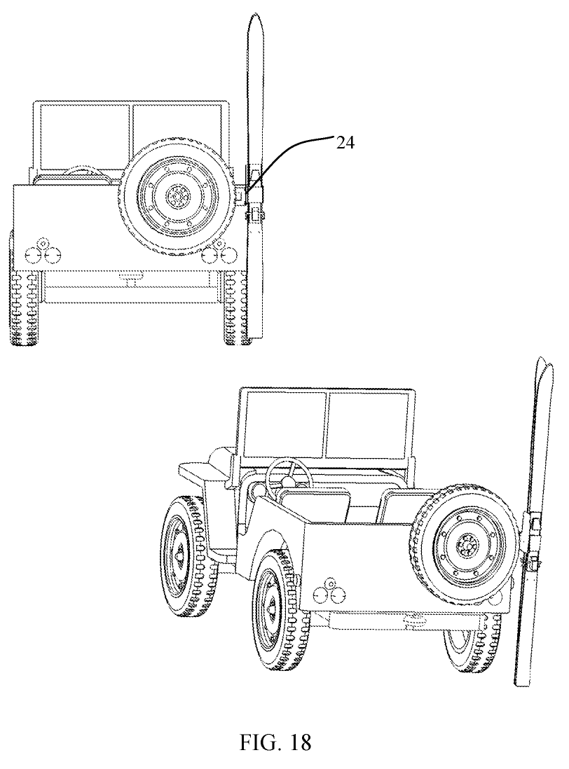

As depicted in FIG. 18 one example embodiment of the carrier 04 equipment 24 can be carried in a releasably connected manner at the rear of a vehicle. Connections may include a strap securement mechanism configured to engage a strap or webbing, which may be the same as, or different from, the connector mechanism described above.

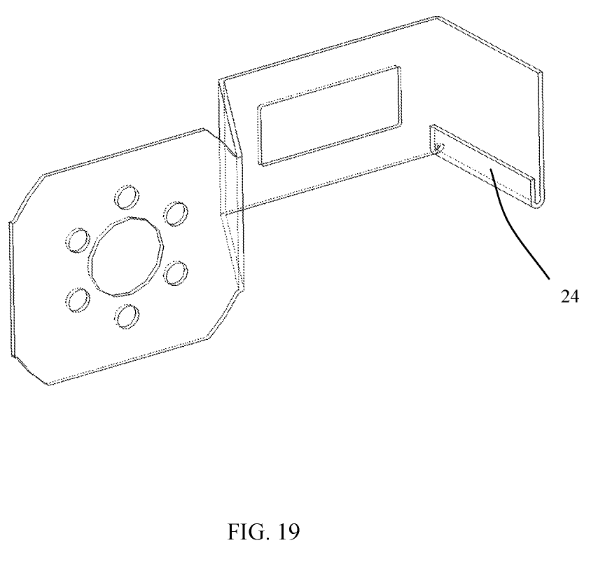

As depicted in FIG. 19 one example embodiment of a cargo load carrier 04 is shown as having a single side with three main frame elements, a tire mount segment 05, a variable length and width support member 06, and a variably configured equipment attachment segment 07. This configuration could be used where one single equipment mount would be desired. The equipment-retaining segment 18 can be slidingly cooperative and engaged with the single hem 25 of the carrier 04.

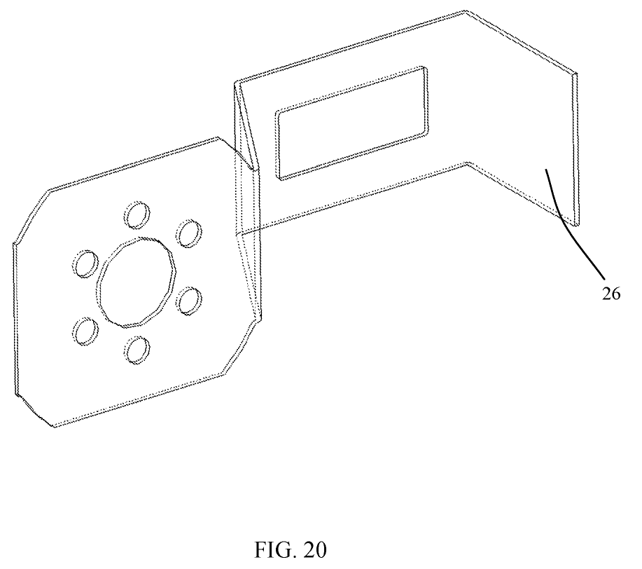

As depicted in FIG. 20 one example embodiment of a cargo load carrier 04 is shown as having a single side with three main frame elements, a tire mount segment 05, a variable length and width support member 06, and a variably configured equipment attachment segment 07. This configuration could be used where one single equipment mount would be desired. The equipment-retaining segment 18 can be cooperative and engaged with the segment having no hem 26 of the carrier 04 retained with fasteners, spring pins, solid or flexible straps, or adjustable fasteners such as would be known by those skilled in the art of metal or plastic fabrication.

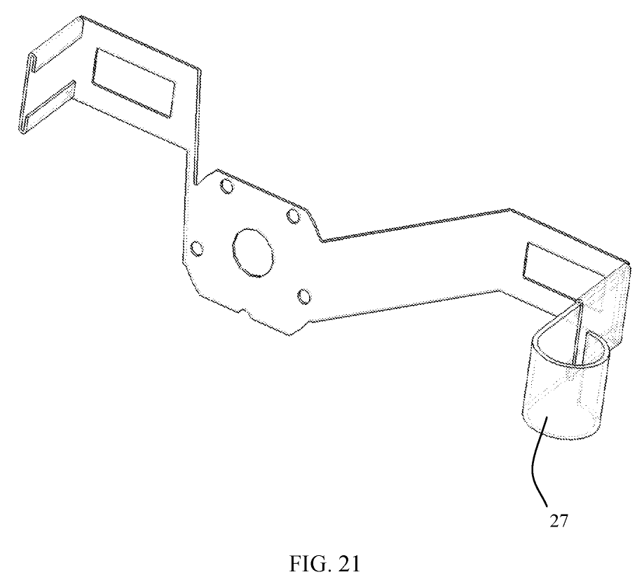

As depicted in FIG. 21 one example embodiment of the carrier 04 comprises a round equipment-retaining segment 27 for retaining equipment abuttingly engaged with the equipment attachment segment 07 allowing for equipment retainers 27 that are permanently connected or releasably connected to the equipment segment. The equipment-retaining segment 27 can be slidingly cooperative and engaged with the hems 14 of the carrier 04. While not shown the equipment holder could be any shape including ovoid and/or polygonal in profile.

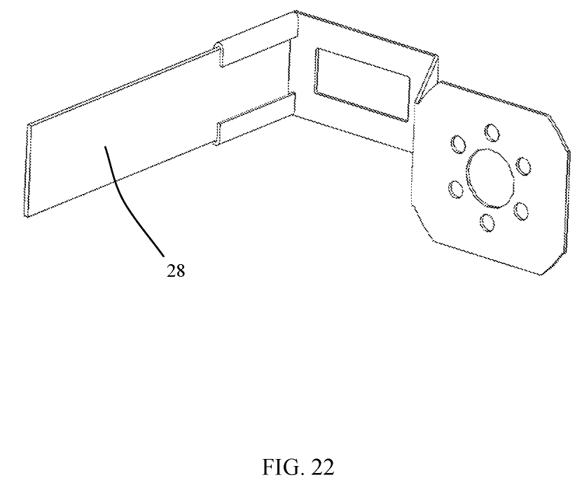

As depicted in FIG. 22 one example embodiment of the carrier 04 comprises an equipment-retaining segment 28 for retaining miscellaneous equipment abuttingly engaged with the equipment attachment segment 07 allowing for equipment retainers 28 that are permanently connected or releasably connected to the equipment segment. The equipment-retaining segment 28 can be slidingly cooperative and engaged with the hems 14 of the carrier 04. The equipment-retaining segment 28 comprises no holes and can be modified by individual users of the equipment to place location holes or other modifications that allow for carrying miscellaneous cargo.

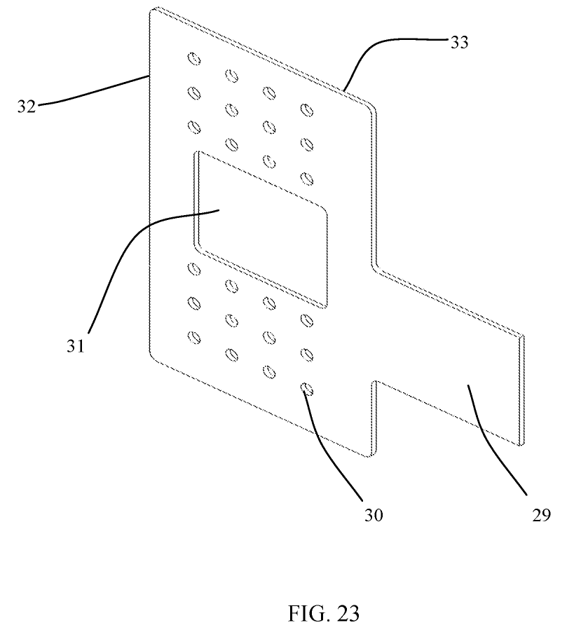

As depicted in FIG. 23 one example embodiment comprises an equipment-retaining segment 29 for retaining miscellaneous equipment abuttingly engaged with the equipment attachment segment 07 allowing for equipment retainers 29 that are permanently connected or releasably connected to the equipment segment. The equipment-retaining segment 29 contains a plurality of attachment holes 30, 31 which can be selected by individual users for carrying miscellaneous cargo retained with set screws, spring pins, solid or flexible straps, or adjustable fasteners such as would be known by those skilled in the art of metal or plastic fabrication. While there are no restrictions on the height 32 or width 33 of the equipment retainers 29 these dimensions would typically not exceed 1 metre in length or width.

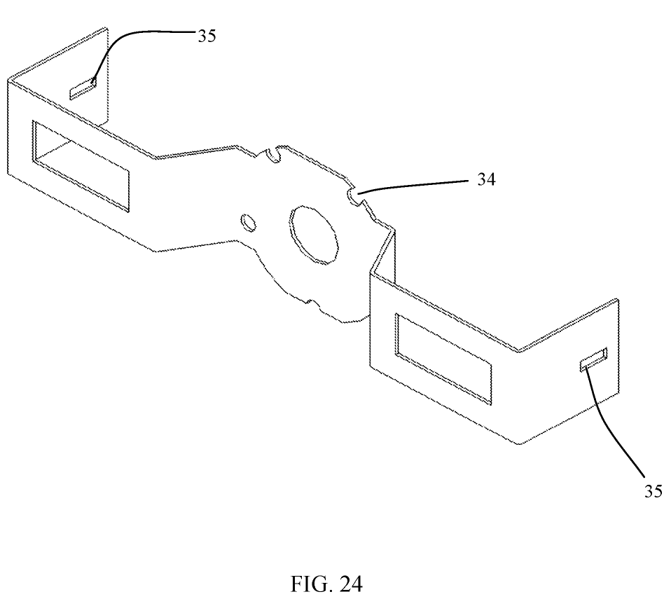

As depicted in FIG. 24 one example embodiment of a cargo load carrier 04 has a plurality of holes 34 arranged in a circular pattern. The plurality of holes 34 provides for placing the carrier 04 onto the rearward tire mounts 03. While shown as full and partial circles, the holes 08 could be any shape or number of holes that allows the lug bolts 02 to pass through the load carrier 04. Other assembly holes 35 may be added as required to allow the carrier 04 to engage with assembly elements 18 to retain equipment retained with set screws, spring pins, solid or flexible straps, or adjustable fasteners such as would be known by those skilled in the art of metal or plastic fabrication. Assembly holes 35 may also be provided as bosses, gussets or other metal or plastic forming clearance regions or other means such as would be known by those skilled in the art of metal or plastic fabrication.

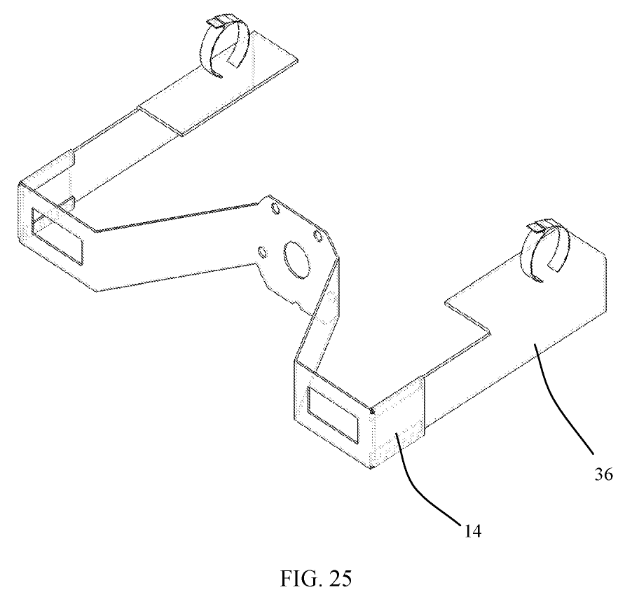

As depicted in FIG. 25 one example embodiment of the carrier 04 comprises an assembly 36 for retaining bicycles or bicycle components. Assembly elements 36 are engaged with equipment-retaining segment 14. The assembly elements 36 can be slidingly cooperative and engaged with equipment-retaining segment 14 and retained with set screws, spring pins, solid or flexible straps, or adjustable fasteners such as would be known by those skilled in the art of metal or plastic fabrication.

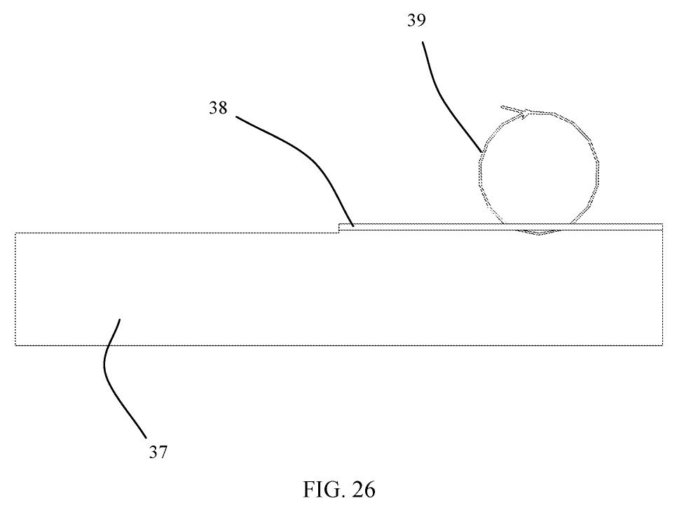

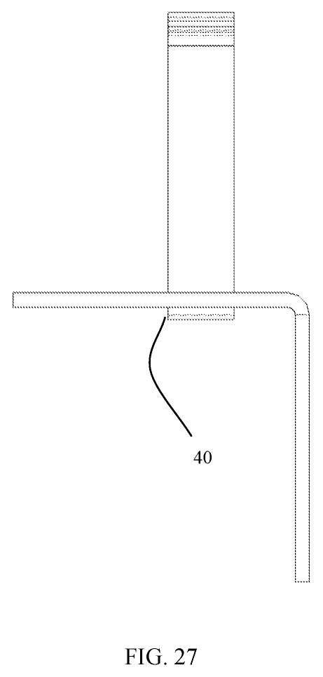

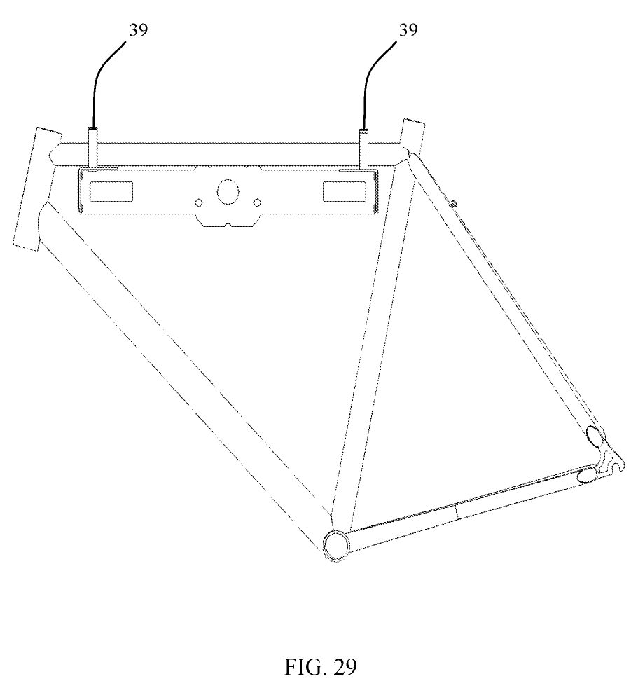

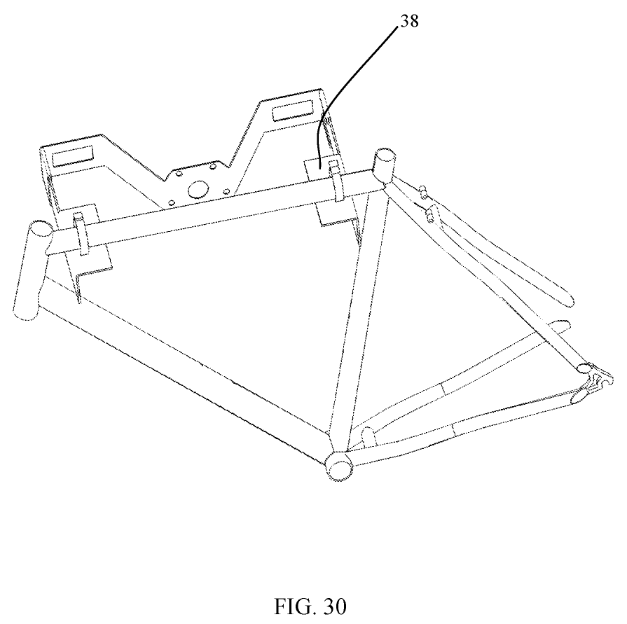

As depicted in FIG. 26, FIG. 27, FIG. 29 and FIG. 30 one example embodiment of the bicycle carrying assembly 36 for retaining bicycles or bicycle components comprises an equipment-retaining segment 37, a spanning-member 38 and a frame-retaining segment 39. Equipment-retaining segment 37 and spanning-member 38 may be configured so that the distance can be lengthened or shortened as desired to fit specific vehicle sizes or to add additional bicycle holders 39 to carry a plurality of bicycles. Bicycle carrying assembly 36 may (but is not required to) include, or be constructed of, a material that allows assembly 36 to maintain a substantially rigid shape, including in an arcuate shape. Additionally or alternatively, as schematically illustrated at 39 and 40, spanning members according to the present disclosure may include a strap securement mechanism configured to engage a strap or webbing and retaining clip. Alternatively, a bicycle frame holder can be used which may be the same as, or different from, the connector mechanism described above. For example, a spanning member may have a rigid lock mechanism or other structure configured to secure an end, or a combination of, a length of strap or webbing and rigid fixation.

As depicted in FIG. 26 and FIG. 27 in some embodiments webbing 40 may be inserted through holes in spanning-member 38 as a means to secure webbing to the spanning-member. Additionally or alternatively spanning members may (but are not required to) include one or more channels for receiving and engaging a corresponding strap.

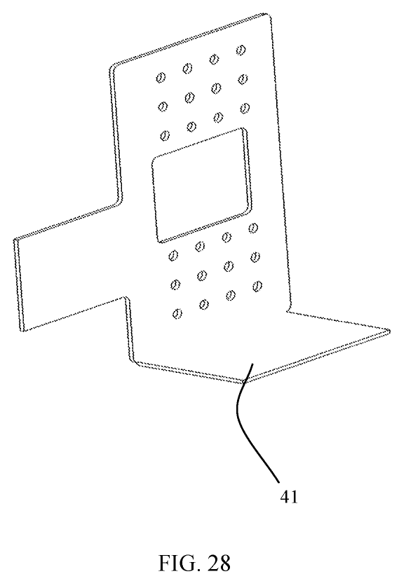

As depicted in FIG. 28 one example embodiment comprises an equipment-retaining segment 41 for retaining miscellaneous equipment abuttingly engaged with the equipment attachment segment 07 allowing for equipment retainers that are permanently connected or releasably connected to the equipment segment. In some embodiments webbing may be inserted through holes in equipment-retaining segment 41 as a means to secure webbing to the spanning-member. Additionally or alternatively spanning members may (but are not required to) include one or more channels for receiving and engaging a corresponding strap. The equipment-retaining segment 41 contains a plurality of attachment holes which can be selected by individual users for carrying miscellaneous cargo retained with set screws, spring pins, solid or flexible straps, or adjustable fasteners such as would be known by those skilled in the art of metal or plastic fabrication. While there are no restrictions on the height or width of the equipment retainer 41 dimensions would typically not exceed 1 metre in length or width.

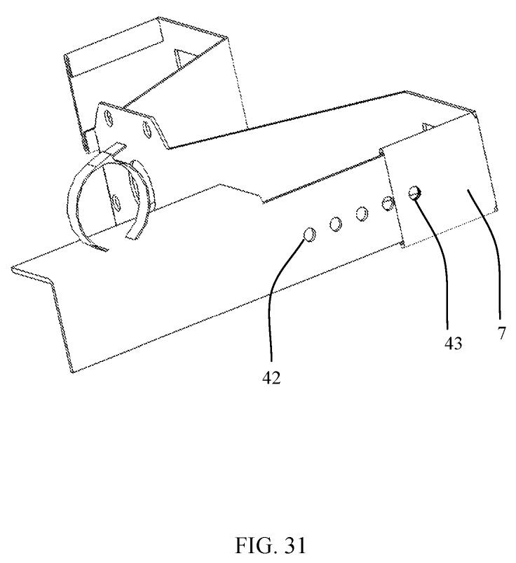

As depicted in FIG. 31 one example embodiment of the bicycle carrying assembly 36 for retaining bicycles or bicycle components comprises an equipment-retaining segment 37, a spanning-member 38 and a frame-retaining segment 39. Spanning-member 38 may be configured with a single or plurality of holes for securing to equipment attachment segment 07. Equipment attachment segment 07 may (but is not required to) have a corresponding single or plurality of holes 43 to provide for securing bicycle-carrying assembly 36 to equipment attachment segment 07. While the configuration shown in FIG. 31 is for bicycle carrying, the configuration can be utilized for any type of equipment carrying described above.

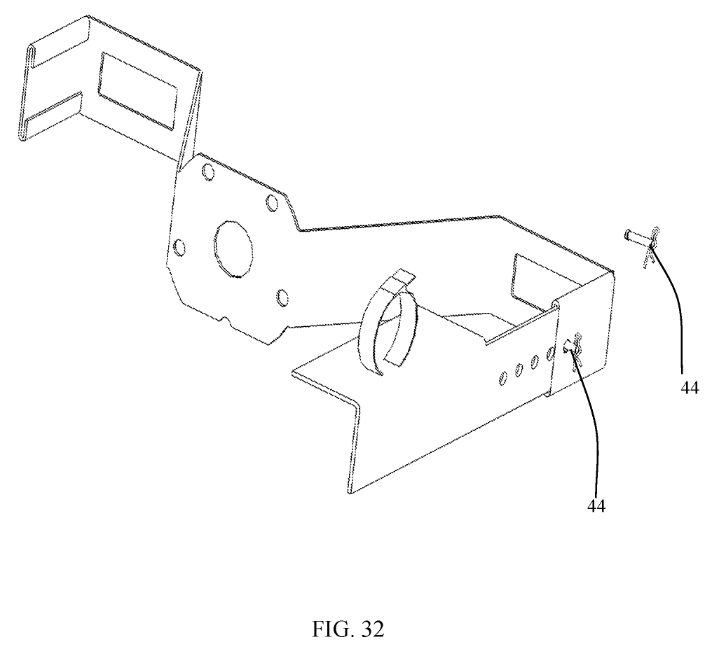

As depicted in FIG. 32 one example embodiment of the bicycle carrying assembly 36 spanning-member 38 may be configured with a single or plurality of holes for securing to equipment attachment segment 07 and secured using a standard spring pin 44. Additionally or alternatively, spanning-member 38 may be configured with a single or plurality of holes for securing to equipment attachment segment 07 and secured using a strap securement mechanism configured to engage a strap or webbing and retaining clip, or other means such as would be known by those skilled in the art of metal or plastic fabrication.

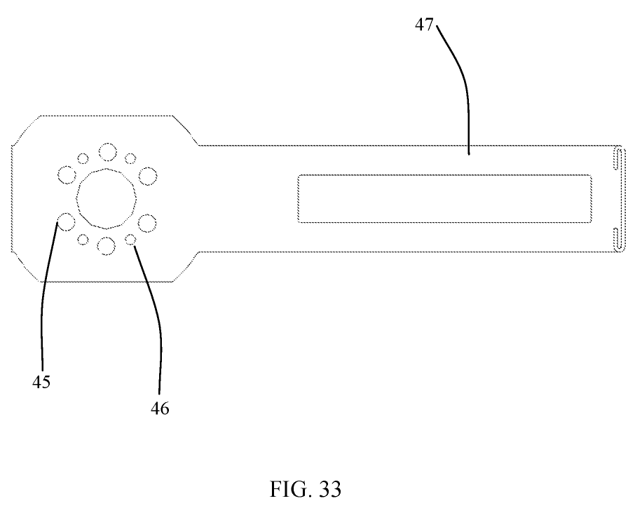

As depicted in FIG. 33 one example embodiment of a cargo load carrier 04 has an elongated a variable length and width support member 47.

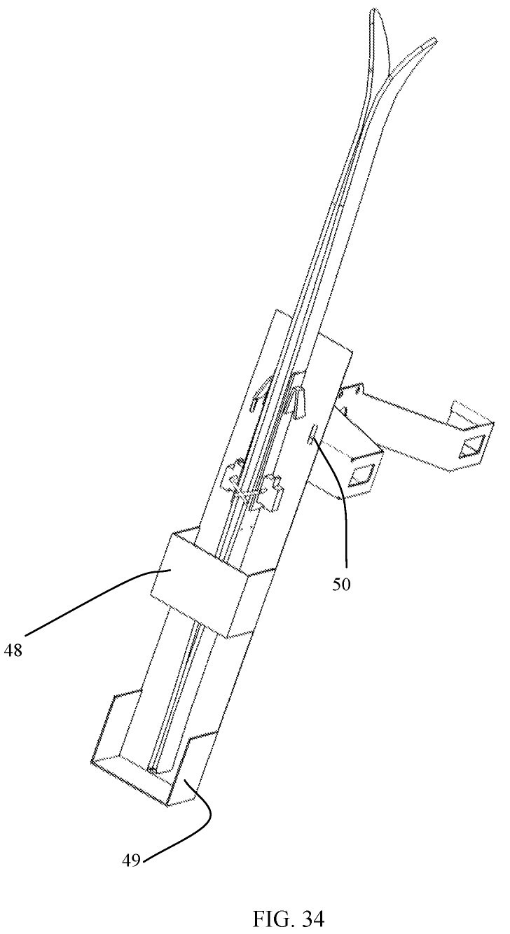

As depicted in FIG. 34 one example embodiment of a semi-enclosed ski or snowboard carrying assembly for retaining snow sport components comprises an equipment-retaining segment 48, a base retaining member 49. Equipment-retaining segment 48 may be configured with a single or plurality of holes 50 for securing to equipment attachment segment 07. Equipment-retaining segment 48 may (but is not required to) have a corresponding single or plurality of holes 50 to provide for securing to equipment attachment segment 07. The equipment-retaining segment 48 contains a plurality of attachment holes which can be selected by individual users for carrying miscellaneous cargo retained with set screws, spring pins, solid or flexible straps, locking mechanism or adjustable fasteners such as would be known by those skilled in the art of metal or plastic fabrication. While the carrying assembly is shown as semi-enclosed, the assembly can be provided in a fully enclosed configuration.

The embodiments shown and described above are only examples. For simplicity, some details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. An attachable and/or removable multi-task equipment carrier for transporting cargo at the rear of a vehicle comprising:
a mount in abutment with rearward vehicle tire mounts; a mount provided with a plurality of holes, abuttingly engaged with the rearward tire mounts wherin the carrier can be provided to fit any rear mount spare tire carrier lug nut configuration; at least one single support member extending from a mount, or multiple support members extending from a mount with said support member or members slidingly and/or mechanically engaged with variable and exchangeable cargo carrying attachments; variable and exchangeable equipment carriers slidingly and/or mechanically engaged with variable and exchangeable cargo carrying attachments adapted to snow sport equipment, bicycle or miscellaneous cargo; and a mount which can secured in place by replacing the spare tire and a single or plurality of lug nuts.

2. The assembly of claim 1, wherein a tire mount segment is provided with a plurality of holes and radial hole patterns to fit any lug nut bolt pattern.

3. The assembly of claim 1, wherein a tire mount segment is provided with a plurality of holes, gussets, bosses or hems to allow the tire mount segment to be abuttingly engaged with the rearward tire mounts when said mounts have features other than lug nuts that would prevent abutment.

4. The assembly of claim 1, wherein a variable length support segments are provided with a plurality of holes to allow fitment with any rear vehicle rearward configuration and tire size.

5. The assembly of claim 1, wherein a fixed size or adjustable equipment attachment segments are provided allow fitment with any winter sport, bicycle or miscellaneous cargo.

6. The assembly of claim 1, further including materials of uniform or multiple thicknesses.

7. The assembly of claim 1, wherein the tire mount, support and equipment and/or cargo carrying segments can be permanently or removably attached as a whole or between two segments.

8. The assembly of claim 1, wherein the ski rack assembly has one single or a plurality of sides for carrying skis or snowboards or other winter sport equipment, and at least one cooperatively engaged rigid and/or flexible clamp device on each side of the ski rack assembly having an optional or installed for preventing unauthorized removal of skis or snowboards carried on the rack assembly.

9. The assembly of claim 1, wherein the ski rack assembly has one single or a plurality of sides for carrying miscellaneous equipment, including equipment fully or partially comprised of ski poles, and the assembly has at least one cooperatively engaged rigid and/or flexible clamp device on each side of cargo carrying assembly having a lock for preventing unauthorized removal of skis or snowboards carried on the rack assembly.

10. The assembly of claim 1, wherein the cargo assembly has one single or a plurality of sides, base plates and holes for carrying miscellaneous equipment, including equipment fully or partially comprised of soft and/or rigid wall containers, and the assembly has at least one cooperatively engaged rigid and/or flexible clamp device on each side of cargo carrying assembly having a lock for preventing unauthorized removal of skis or snowboards carried on the rack assembly.

11. The assembly of clam 1, wherin the mount, single or multiple support members and equipment and/or cargo carrying segments can be permanently or removably cooperatively engaged using single of a plurality of sheet metal hems.

12. The assembly of claim 1, wherein a bicycle carrier assembly has one single or a plurality of sides for carrying bicycles or similarly shaped equipment, and at least one cooperatively engaged rigid and/or flexible clamp device on each side of the bicycle carrier assembly having an optional or installed lock for preventing unauthorized removal of skis or snowboards carried on the rack assembly.

13. The assembly of claim 1, wherein a semi-enclosed ski or snowboard carrying assembly has one single or a plurality of enclosed or semi-enclosed containers for carrying skis or snowboards or other winter sport equipment, and at least one cooperatively engaged rigid and/or flexible clamp device on each side of the ski rack assembly having an optional or installed for preventing unauthorized removal of skis or snow boards carried on the rack assembly.

14. An attachable and/or removable multi-task equipment carrier for transporting cargo at the rear of a vehicle comprising a rear spare tire mount with: (A) a mount segment in abutment with rearward vehicle tire mounts; (B) a mount segment provided with a plurality of holes, abuttingly engaged with the rearward tire mounts wherin the carrier can be provided to fit any rear mount spare tire carrier lug nut configuration; (C) single or multiple support members extending from a mount segment, with said support member slidingly, permanently, releasably and/or mechanically engaged with variable and exchangeable cargo carrying attachments; (D) variable and exchangeable equipment carriers slidingly, permanently, releasably and/or mechanically engaged with variable and exchangeable cargo carrying attachments adapted to snow sport equipment, bicycle or miscellaneous cargo; and (E) a mount segment which can secured in place by replacing the spare tire and a single or plurality of lug nuts or other attachment methods not requiring lug nuts.
